(19) United States
(12) Patent Application Publication
(10) Pub. No.: US 2025/0304734 A1
(43) Pub. Date: Oct. 2, 2025

(54) CROSS-LINKABLE AND CHARGED ZWITTERIONIC POLYMERS AND MEMBRANES COMPRISING SAME

(71) Applicants: TRUSTEES OF TUFTS COLLEGE, Medford, MA (US); ZWITTERCO, INC, Woburn, MA (US)

(72) Inventor: Samuel J. Lounder, Somerville, MA (US)

(21) Appl. No.: 18/864,110

(22) PCT Filed: May 12, 2023
(86) PCT No.: PCT/US2023/022051

§ 371 Date: Nov. 8, 2024

Related U.S. Application Data
(60) Provisional application No. 63/364,755, filed on May 16, 2022.

(51) Int. Cl. C08F 220/40; B01D 67/00; B01D 69/02; B01D 69/12; B01D 71/40; C08F 220/38

(52) U.S. Cl. CPC C08F 220/40; B01D 67/0006; B01D 67/009; B01D 69/02; B01D 69/1214; B01D 71/4011; C08F 220/382; C08F 220/387; B01D 2323/21829; B01D 2323/30; B01D 2323/345; B01D 2323/385; B01D 2325/02831; B01D 2325/02832; B01D 2325/04; B01D 2325/18

(57) ABSTRACT

This disclosure generally relates to polymeric materials designed to create membranes with improved selectivity and fouling resistance, with potential capabilities that include tunable effective pore size that can be reduced to, for example, <1 nm, exceptional fouling resistance, improved chemical resistance and thermal stability, and ion selectivity. Specifically, this disclosure relates to cross-linkable and charged zwitterionic polymers and membranes made therefrom for reverse osmosis applications.

### CROSS-REFERENCE TO RELATED APPLICATIONS

This application claims the benefit of priority to U.S. Provisional Patent Application No. 63/364,755, filed on May 16, 2022, the disclosure of which is hereby incorporated by reference herein in its entirety.

### FIELD OF THE DISCLOSURE

This disclosure relates generally to cross-linkable and charged zwitterionic polymers and membranes made therefrom for reverse osmosis applications.

### BACKGROUND

Membrane filtration is an important and promising method of water purification, reclamation and reuse. Membranes of various pore sizes can be used for a wide range of objectives, from simply removing disease-causing microorganisms to desalination by reverse osmosis (RO). Membranes also serve as an efficient, simple, scalable separation method in various industries, such as food, beverage, dairy, and bio/pharmaceutical industries.

Membranes with improved selectivity, or ability to separate solutes with better precision, offer to improve the economic feasibility and energy efficiency of several other processes. For instance, membranes with improved selectivity between sulfate and chloride anions could alter the composition of seawater and wastewater for use as drilling fluid in offshore oil wells while operating at lower applied pressures. Membranes with extremely small pore sizes but low salt rejection can lead to highly improved effluent quality for challenging wastewater streams, particularly those with high organic content, such as those from the food industry.

All of the aforementioned membrane processes are often severely impacted by fouling, defined as the degradation of membrane performance due to the adsorption and accumulation of feed components on the membrane surface. Severe declines in membrane permeability and changes in membrane selectivity are common. Fouling management is a significant component of costs associated with membrane systems, requiring increased energy use, regular cleanings involving downtime, maintenance and chemical use, and more complex processes.

### SUMMARY

Provided herein are polymeric materials designed to create membranes with improved selectivity and fouling resistance, with potential capabilities that include tunable effective pore size that can be reduced to <1 nm, exceptional fouling resistance, improved chemical resistance and thermal stability, and ion selectivity.

In various implementations, the present disclosure relates to zwitterionic polymers and membranes made therefrom. The present disclosure includes, without limitation, the following example implementations.

Embodiment 1: A copolymer, comprising a plurality of first repeat units, wherein the repeat units are zwitterionic; a plurality of second repeat units: wherein at least some of the second repeat units each independently comprise a cross-linkable moiety; and a plurality of third repeat units, wherein at least some of the third repeat units are ionizable and the second repeat units and the third repeat units are different.

Embodiment 2: The copolymer of the preceding Embodiment, wherein each of the first repeat units independently comprises sulfobetaine, carboxybetaine, phosphorylcholine, imidazolium alkyl sulfonate, pyridinium alkyl sulfonate, or a carboxybetaine group.

Embodiment 3: The copolymer of Embodiment 1 or 2, or any combination thereof, wherein each of the zwitterionic repeat units is independently formed from sulfobetaine acrylate, sulfobetaine acrylamide, carboxybetaine acrylate, carboxybetaine methacrylate, 2-methacryloyloxyethyl phosphorylcholine, acryloxy phosphorylcholine, phosphorylcholine acrylamide, phosphorylcholine methacrylamide, carboxybetaine acrylamide, carboxybetaine vinyl pyridine, carboxybetaine vinyl imidazole, 3-(2-vinylpyridinium-1-yl)propane-1-sulfonate, 3-(4-vinylpyridinium-1-yl)propane-1-sulfonate, sulfobetaine methacrylate, or combinations thereof.

Embodiment 4: The copolymer of any one of Embodiments 1 to 3, or any combination thereof, wherein at least a portion of the second repeat units comprise hydrophobic repeat units.

Embodiment 5: The copolymer of any one of Embodiments 1 to 4, or any combination thereof, wherein at least a portion of the second repeat units comprise hydrophillic repeat units.

Embodiment 6: The copolymer of any one of Embodiments 1 to 5, or any combination thereof, wherein the hydrophobic repeat units are independently formed from a styrene, an alkyl acrylate, an alkyl methacrylate, an alkyl acrylamide, an acrylonitrile, an aryl acrylate, an aryl methacrylate, an aryl acrylamide, an allyl acrylate, an allyl acrylamide, an allyl methacrylamide, a vinyl methacrylate, a vinyl methacrylamide, a vinyl acrylamide, an allyl vinyl benzene (styrene derivative), a cinnamate, benzophenone, isopropyl thioxanthone, or combinations thereof.

Embodiment 7: The copolymer of any one of Embodiments 1 to 6, or any combination thereof, wherein a second portion of the second repeat units comprise a second type of hydrophobic repeat units.

Embodiment 8: The copolymer of any one of Embodiments 1 to 7, or any combination thereof, wherein the second type of hydrophobic repeat units are each independently formed from an alkyl acrylate, an alkyl methacrylate, an alkyl acrylamide, an acrylonitrile, an aryl acrylate, an aryl methacrylate, an aryl acrylamide, a trifluoroethyl methacrylate, a methyl methacrylate, an ethyl methacrylate, a n-propyl methacrylate, a n-butyl methacrylate, an acrylonitrile, a styrene, or combinations thereof.

Embodiment 9: The copolymer of any one of Embodiments 1 to 8, or any combination thereof, wherein at least some of the second repeat units do not comprise a cross-linkable moiety.

Embodiment 10: The copolymer of any one of Embodiments 1 to 9, or any combination thereof, wherein the second repeat units that do not comprise a cross-linkable moiety are each independently formed from an acrylate, a methacrylate, an acrylamide, a methacrylamide, a trifluoroethyl methacrylate, a methyl methacrylate, an ethyl methacrylate, a n-propyl methacrylate, a n-butyl methacrylate, acrylonitrile, a styrene, or combinations thereof.

Embodiment 11: The copolymer of any one of Embodiments 1 to 10, or any combination thereof, wherein the cross-linkable moiety comprises a carbon-carbon double bond.

Embodiment 12: The copolymer of any one of Embodiments 1 to 11, or any combination thereof, wherein the cross-linkable moiety comprises an allyl (CH2-CH═CH2), a vinyl (—CH═CH2 or —CH═CH—), a vinyl ether (—O—CH═CH2), or a vinyl ester (—CO—O—CH═CH2).

Embodiment 13: The copolymer of any one of Embodiments 1 to 12, or any combination thereof, wherein the cross-linkable moiety is polymerized (e.g., cross-linked) via exposure to one or more of a free radical photoinitiator, electromagnetic radiation, such as, for example, UV light or an electron beam, high temperature, a redox reaction, or combinations thereof.

Embodiment 14: The copolymer of any one of Embodiments 1 to 13, or any combination thereof, wherein each of the ionizable third repeat units is independently formed from a 3-sulfopropyl methacrylate potassium salt, a methacrylate, an acrylate, an acrylamide a styrene derivative comprising one or more of a carboxylate, a carboxylic acid, a sulfonate, a sulfonic acid, an amine, an amino acid, a phosphate, a phosphonic acid, a phosphonium, a boronate, or a boronic acid, or combinations thereof.

Embodiment 15: The copolymer of any one of Embodiments 1 to 14, or any combination thereof, wherein the copolymer has a molecular weight of about 10,000 to about 10,000,000 Dalton, preferably about 20,000 to about 500,000 Dalton, and more preferably about 20,000 to about 100,000 Dalton. Generally, the specific molecular weight of the copolymer will be selected to suit a particular application.

Embodiment 16: The copolymer of any one of Embodiments 1 to 15, or any combination thereof, wherein the first repeat units constitute about 5 to about 95% by weight of the copolymer, preferably about 10 to about 90%, more preferably about 20 to about 80%, and even more preferably about 25 to about 75%.

Embodiment 17: The copolymer of any one of Embodiments 1 to 16, or any combination thereof, wherein the second repeat units constitute about 5 to about 95% by weight of the copolymer, preferably about 10 to about 90%, more preferably about 20 to about 80%, and even more preferably about 25 to about 75%.

Embodiment 18: The copolymer of any one of Embodiments 1 to 17, or any combination thereof, wherein the third repeat units constitute about 5 to about 95% by weight of the copolymer, preferably about 10 to about 90%, more preferably about 20 to about 80%, and even more preferably about 25 to about 75%. Generally, the specific combinations of monomers and their weight ranges will vary to suit a particular application.

Embodiment 19: A cross-linked copolymer network comprising the copolymer of any one of Embodiments 1 to 18, or any combination thereof.

Embodiment 20: A thin film composite membrane comprising a porous substrate and a selective layer comprising the cross-linked copolymer network of Embodiment 19.

Embodiment 21: The membrane of the preceding Embodiment, wherein the average effective pore size of the porous substrate is larger than the average effective pore size of the selective layer.

Embodiment 22: The membrane of Embodiment 20 or 21, or any combination thereof, wherein the selective layer is disposed on top of the porous substrate.

Embodiment 23: The membrane of any one of Embodiments 20 to 22, or any combination thereof, wherein the selective layer has an average effective pore size of about 0.1 nm to about 2.0 nm.

Embodiment 24: The membrane of any one of Embodiments 20 to 23, or any combination thereof, wherein the selective layer has an average effective pore size of about 0.1 nm to about 1.2 nm.

Embodiment 25: The membrane of any one of Embodiments 20 to 24, or any combination thereof, wherein the selective layer has an average effective pore size of about 0.5 nm to about 1.0 nm.

Embodiment 26: The membrane of any one of Embodiments 20 to 25, or any combination thereof, wherein the selective layer has a thickness of about 10 nm to about 10 μm.

Embodiment 27: The membrane of any one of Embodiments 20 to 26, or any combination thereof, wherein the selective layer has a thickness of about 100 nm to about 2 μm.

Embodiment 28: The membrane of any one of Embodiment 20 to 27, or any combination thereof, wherein the thin film composite membrane rejects charged solutes and salts.

Embodiment 29: The membrane of any one of Embodiments 20 to 28, or any combination thereof, wherein the selective layer exhibits sulfate (SO₄²⁻rejection of greater than 99%.

Embodiment 30: The membrane of any one of Embodiments 20 to 29, or any combination thereof, wherein the selective layer exhibits sulfate (SO₄²⁻)/chloride (Cl−) separation factor of greater than 50.

Embodiment 31: The membrane of any one of Embodiments 20 to 30, or any combination thereof, wherein the selective layer exhibits sulfate (SO₄²⁻)/chloride (Cl−) separation factor of about 75.

Embodiment 32: The membrane of any one of Embodiments 20 to 31, or any combination thereof, wherein the selective layer exhibits different anion rejections for salts with the same cation.

Embodiment 33: The membrane of any one of Embodiments 20 to 32, or any combination thereof, wherein the selective layer exhibits different anion rejections for salts selected among NaF, NaCl, NaBr, Nal, and NaClO₄.

Embodiment 34: The membrane of any one of Embodiments 20 to 33, or any combination thereof, wherein the selective layer exhibits a fluoride (F−)/chloride (Cl−) separation factor of greater than 5.

Embodiment 35: The membrane of any one of Embodiments 20 to 34, or any

combination thereof, wherein the selective layer exhibits a fluoride (F−)/chloride (Cl−) separation factor of about 8.

Embodiment 36: The membrane of any one of Embodiments 20 to 35, or any

combination thereof, wherein the selective layer exhibits different rejections for monosaccharides and disaccharides.

Embodiment 37: The membrane of any one of Embodiments 20 to 36, or any

combination thereof, wherein the selective layer exhibits a glucose/sucrose separation factor of greater than 10.

Embodiment 38: The membrane of any one of Embodiments 20 to 37, or any combination thereof, wherein the selective layer exhibits a xylose/sucrose separation factor of greater than 18.

Embodiment 39: The membrane of any one of Embodiments 20 to 38, or any combination thereof, wherein the selective layer exhibits resistance to fouling by an oil emulsion.

Embodiment 40: The membrane of any one of Embodiments 20 to 39, or any combination thereof, wherein the selective layer is stable upon exposure to chlorine bleach (e.g., at pH 4).

Embodiment 41: The membrane of any one of Embodiments 20 to 40, or any combination thereof, wherein the selective layer exhibits size-based selectivity between uncharged organic molecules.

Embodiment 42: The membrane of any one of Embodiments 20 to 41, or any combination thereof, wherein the selective layer exhibits rejection of >99% for neutral molecules with hydrated diameters of about or greater than 1 nm.

Embodiment 43: A method of making a thin film composite membrane comprising providing the copolymer of any one of Embodiments 1 to 18, or any combination thereof; depositing the copolymer on to a porous substrate; and activating the cross-linkable groups of the copolymer to form additional bonds therebetween.

Embodiment 44: The method of making the membrane of the preceding embodiment, wherein the step of activating the cross-linkable groups of the copolymer comprises one or more of exposing the membrane to a free radical photoinitiator, electromagnetic radiation, a free radical photoinitiator and a dithiol, or combinations thereof.

Embodiment 45: The method of making the membrane of embodiment 43 or 44, or any combination thereof, wherein the step of exposing the membrane to a free radical photoinitiator comprises exposing the membrane to a solvent containing the free radical photoinitiator and/or a free radical photoinitiator and a dithiol. Exposing the membrane to the solvent may include, for example, immersing in, dipping in, coating with, rinsing with, or otherwise wetting the targeted portions (e.g., the cross-linkable groups of the copolymer) of the membrane.

Embodiment 46: The method of making the membrane of embodiment 43 to 45, or any combination thereof, wherein the step of exposing the membrane to electromagnetic radiation comprises exposing the membrane to ultraviolet light, an electron beam, or otherwise irradiating the targeted portions (e.g., the cross-linkable groups of the copolymer) of the membrane.

Generally, additional treatment steps are contemplated and considered within the scope of the invention, such as, for example, quenching, surface modification, cleaning, deactivating, etc., and may be carried out with different solvents, radiation ranges, and processing times.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### DETAILED DESCRIPTION

Disclosed are a family of polymeric materials that comprise at least three types of repeat units: a cross-linkable monomer, a zwitterionic monomer, and an ionic or ionizable monomer. This disclosure enables the facile preparation of reverse osmosis membranes with a novel polymer chemistry. These membranes preferably have improved fouling resistance, chlorine tolerance, and stability (e.g. against chemical or thermal damage).

The cross-linkable monomer: A typical cross-linkable moiety is a C═C double bond, which can be polymerized upon exposure to a free radical photoinitiator, including one activated by ultraviolet (UV) light or an electron beam. It may also be possible to do this using thermal methods (i.e. using an initiator activated at higher temperatures), or through a redox reaction. The cross-linkable moiety may not be C═C double bond and could instead be polymerized by exposure to UV light in the absence of radical initiators.

The zwitterionic monomer: Serves to impart water permeability and fouling resistance to the membrane selective layer.

The ionic or ionizable monomer: When the monomer is ionic, it possesses a net-charge over a given range of pH, preferably but not necessarily a wide range of pH. When the monomer is ionizable, it is initially neutral but can attain a net-charge through some ionization reaction (e.g. deprotonation or protonation) over a given range of pH. Ionic or ionizable monomers will herein be referred to as ionic/ionizable monomers.

The material can also include an additional hydrophobic repeat unit that is not cross-linkable. This additional hydrophobic repeat unit might be an acrylate, methacrylate, acrylamide, methacrylamide, or styrene derivatives. Some examples of additional hydrophobic repeat units include trifluoroethyl methacrylate, methyl methacrylate, ethyl methacrylate, n-propyl methacrylate, n-butyl methacrylate, acrylonitrile, and styrene.

Generally, these copolymers can be synthesized by methods well-known in polymer science. If the cross-linkable group includes a C═C double bond, such as a vinyl or allyl group, this copolymer may be synthesized using controlled free radical methods that interact only with more reactive polymerizable groups, e.g., atom transfer radical polymerization (ATRP) and its modified versions such as atom regeneration transfer ATRP (ARGET-ATRP), nitroxide-mediated polymerization (NMP), or reversible addition fragmentation transfer (RAFT) polymerization. It may also be possible to prepare these polymers using regular free radical polymerization while carefully controlling polymerization conditions (e.g. highly dilute solution, low conversion).

In various embodiments, the copolymers are statistical copolymers and may incorporate the different types of repeat units in roughly random order (as opposed to blocks). Additionally, the copolymers may be of mostly linear architecture. In certain embodiments, the copolymers are linear. In certain embodiments, the copolymers are branched.

In various embodiments, the copolymers may have a molecular weight above 5,000 g/mol, preferably above 30,000 g/mol, even more preferably above 100,000 g/mol.

In various embodiments, the copolymers contain zwitterionic repeat units at a concentration between 10-90 wt %, more preferably 20-80 wt %, and even more preferably between 25-75 wt %.

In one embodiment, all hydrophobic repeat units are cross-linkable. In another embodiment, three monomers are used: a cross-linkable monomer, a non-crosslinkable hydrophobic monomer, and a zwitterionic monomer.

In one example, allyl methacrylate (AMA) was used as the cross-linkable monomer. Other acrylate, methacrylate, acrylamide, methacrylamide, and styrene derivatives that include an allyl (CH₂—CH═CH>), vinyl (—CH═CH₂ or —CH═CH—), vinyl ether (—O—CH═CH₂), and vinyl ester (—CO—O—CH═CH₂) groups in their side-groups are also amenable to similar treatment. These functional groups are polymerizable by free radical polymerization, but significantly less reactive than acrylate, methacrylate, styrene, acrylamide and methacrylamide groups, particularly in the controlled free radical polymerization methods described herein. Some possible cross-linkable monomers include (but are not limited to): allyl acrylate, allyl acrylamide, allyl methacrylamide, vinyl methacrylate, vinyl methacrylamide, vinyl acrylamide, allyl vinyl benzene (styrene derivative), other alkenyl acrylates/methacrylates/acrylamides/styrenes (e.g. undecenyl acrylate), and monomers with other double bond containing side-groups (e.g. ethylene glycol dicyclopentenyl ether methacrylate, ethylene glycol dicyclopentenyl ether acrylate). Additional monomers that can undergo cross-linking include acrylate, methacrylate, acrylamide, methacrylamide, and styrene derivatives that include cinnamate (C₆H₅CH═CHCO₂), benzophenone (C₆H₂)₂CO), and Isopropyl thioxanthone (C₁₆H₁₄OS). All three of these side groups can be cross-linked by ultraviolet treatment without the use of a radical initiator, and the final two of these side groups can potentially be used in combination with a synergist such as a tertiary amine.

In the same example, sulfobetaine methacrylate (SBMA) was used as the zwitterionic monomer. However, there is a wide swath of zwitterionic monomers that will be viable. Monomers that include sulfobetaine, phosphorylcholine, and carboxybetaine groups attached to acrylate, methacrylate, acrylamide, methacrylamide, vinyl pyridine, vinyl imidazole, and many other polymerizable groups are viable options.

In the same example, 3-sulfopropyl methacrylate potassium salt (SPMA) was used as the ionic/ionizable monomer. Other examples of ionic/ionizable monomers include methacrylate, acrylate, acrylamide or styrene derivatives containing carboxylate, carboxylic acid, sulfonate, sulfonic acid, amine, amino, phosphate, phosphonic acid, phosphonium, boronate, boronic acid, or other ionic/ionizable groups. The ionic/ionizable groups may contain multiple ionic or ionizable groups such that the charge of the molecule is greater than or equal to +2 for cations or less than or equal to −2 for anions.

If used, the non-crosslinkable hydrophobic monomer can be selected among a broad range. Homopolymers formed from preferred monomers are insoluble in water under operating conditions. Fluoralkyl and alkyl-, and fluoroaryl and aryl-substituted acrylates, methacrylates, acrylamides and methacrylamides, styrene and its derivatives, acrylonitrile and methacrylonitrile are all viable options for this hydrophobic monomer. In some embodiments, the homopolymer of this hydrophobic monomer has a glass transition temperature above 0° C., but this is not required. We have used trifluoromethyl methacrylate (TFEMA) for this purpose.

To form the membrane, these copolymers are coated onto a porous support by methods well-understood in the membrane industry (e.g., doctor blade coating, spray coating). Upon deposition, the zwitterionic and ionic/ionizable groups are expected to form clusters due to Coulombic interactions.

After this membrane is formed, the cross-linkable groups on the copolymer chains are activated to form additional bonds between them. In one embodiment, this is done by first exposing the membrane to a solvent containing a free radical photoinitiator, then exposing the membrane to ultraviolet light and/or an electron beam. This activates the double bonds on the copolymer, creating bonds between polymer chains. In another embodiment, this is done by first exposing the membrane to a solvent containing a free radical photoinitiator and a dithiol, then exposing the membrane to ultraviolet light and/or an electron beam. This activates the double bonds on the copolymer, creating bonds between polymer chains. The dithiol serves to accelerate the cross-linking reaction rate.

Other possible cross-linking approaches may include: No use of solvent during cross-linking (e.g., the photoinitiator can be added to the solution from which the copolymer is coated onto the support) and then exposing the coated membrane to electromagnetic radiation (e.g., UV light); use of a thermal free radical initiator in place of the photoinitiator and cross-linking by exposure to high temperatures; use of high intensity UV with no photoinitiator; thermal cross-linking without an initiator; and/or use of a redox initiator in place of the photoinitiator.

Upon cross-linking, the membrane selective layer has enhanced chemical and physical stability. The performance of the layer would be expected to remain stable through a wider operating window, enabling its use at higher temperatures and/or with more complex feeds containing higher salt concentrations, some solvents, etc.

The cross-linking process may also be used to adjust and improve the selectivity of the membrane. Specifically, if during cross-linking, the membrane is exposed to a solvent that preferentially swells the hydrophobic domains as opposed to the zwitterionic domains, the effective pore size of the membrane can be decreased to <1 nm, as low as 0.74 nm, and possibly even lower as measured using sugar molecule rejections.

Additional details regarding the manufacture of the membranes disclosed herein may be found in PCT Publication Nos. WO2021/232018 and WO2020/231797, and the following articles: Lounder, S. J., Asatekin, A. Zwitterionic Ion-Selective Membranes with Tunable Subnanometer Pores and Excellent Fouling Resistance. Chem. Mater. 2021, 33, 12, 4408-4416 and Lounder, S. J., Asatekin, A. Interaction-Based Ion Selectivity Exhibited by Self-Assembled, Cross-Linked Zwitterionic Copolymer Membranes. Proc Natl Acad Sci USA (In Proof, 2021); the entire disclosures of which are hereby incorporated by reference herein.

### EXAMPLES

In order that the invention described herein may be more fully understood, the following examples are set forth. The examples described in this application are offered to illustrate the compounds, compositions, materials, device, and methods provided herein and are not to be construed in any way as limiting their scope.

### Polymer Synthesis

Copolymers of allyl methacrylate (AMA), sulfobetaine methacrylate (SBMA), and 3-sulfopropyl methacrylate potassium salt (SPMA) were synthesized by Activators ReGenerated by Electron Transfer Atom Transfer Radical Polymerization (ARGET-ATRP). Table 1 summarizes the different reaction solution compositions that were utilized for successful ARGET-ATRP synthesis:

TABLE 1
Polymer Synthesis Summary

| | Composition in reaction solution (wt %) | | |
|---|---|---|---|
| Copolymer | AMA | SBMA | SPMA |
| P1 | 60 | 21 | 19 |
| P2 | 60 | 16 | 24 |
| P3 | 60 | 11 | 29 |

### Membrane Fabrication

TFC membranes were prepared using the three copolymers tabulated above (P1, P2, and P3). To prepare a TFC membrane, a given copolymer was first dissolved in trifluoroethanol (TFE) at 5.0 w/v % (i.e. 5 g polymer/95 mL. TFE). The solution was then passed through a syringe filter and coated onto a support membrane (UE50, Trisep) using a wire wound rod (Gardo, No. 16 wire size). The coated membrane was then transferred to an 80° C. convection oven to evaporate the solvent.

### Membrane Cross-Linking

Membrane disks were cut from the prepared TFC membrane sheet and equilibrated with a UV-active solution composed of isopropyl alcohol (IPA) and UV-active ingredients. To initiate the cross-linking reaction, we then shined UV light (365 nm) on the membrane disk for 2-20 minutes. This led to the photo-polymerization of the AMA groups and resulted in extensive membrane cross-linking for pore size reductions.

The UV-active ingredients for a given cross-linking reaction were either: (1) a photo-initiator or (2) a photo-initiator with a dithiol cross-linking accelerator. The UV-active ingredients that were explored were: 2-hydroxy-2-methylpropiophenone (HOMP); 2,2-dimethoxy-2-phenylacetophenone (DPMA); and 1,6-hexanedithiol (HDT). The UV-active solution compositions are summarized below in Table 2.

TABLE 2
UV-Active Solution Summary

| | | Photo-imitator | | Dithiol Accelerator | |
|---|---|---|---|---|---|
| Cross-Linking | | | Concentration | | Concentration |
| Description | Solvent | Ingredient | (w/v %) | Ingredient | (w/v %) |
| Photo-polymerization using | IPA | HOMP | 3 | none | n/a |
| photo-imitator only | | DMPA | 2 | none | n/a |
| Photo-polymerization using | | HOMP | 3 | HDT | 3 |
| photo-imitator imitator | | HOMP | 1.5 | HDT | 1.5 |
| with a dithiol accelerator | | DMPA | 1.5 | HDT | 1.5 |

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the appended claims. The advantages and objects of the invention are not necessarily encompassed by each embodiment of the invention.

What is claimed is:

1. A copolymer, comprising:
a plurality of first repeat units, wherein the repeat units are zwitterionic;
a plurality of second repeat units; wherein at least some of the second repeat units each independently comprise a cross-linkable moiety; and
a plurality of third repeat units, wherein at least some of the third repeat units are ionizable and the second repeat units and the third repeat units are different.

2. The copolymer of claim 1, wherein each of the first repeat units independently comprises sulfobetaine, carboxybetaine, phosphorylcholine, imidazolium alkyl sulfonate, pyridinium alkyl sulfonate, or a carboxybetaine group.

3. The copolymer of claim 1, wherein each of the zwitterionic repeat units is independently formed from sulfobetaine acrylate, sulfobetaine acrylamide, carboxybetaine acrylate, carboxybetaine methacrylate, 2-methacryloyloxyethyl phosphorylcholine, acryloxy phosphorylcholine, phosphorylcholine acrylamide, phosphorylcholine methacrylamide, carboxybetaine acrylamide, carboxybetaine vinyl pyridine, carboxybetaine vinyl imidazole, 3-(2-vinylpyridinium-1-yl)propane-1-sulfonate, 3-(4-vinylpyridinium-1-yl)propane--1-sulfonate, sulfobetaine methacrylate, or combinations thereof.

4. The copolymer of any one of claims 1-3, wherein at least a portion of the second repeat units comprise hydrophobic repeat units.

5. The copolymer of any one of claims 1-3, wherein at least a portion of the second repeat units comprise hydrophillic repeat units.

6. The copolymer of claim 4, wherein the hydrophobic repeat units are independently formed from a styrene, an alkyl acrylate, an alkyl methacrylate, an alkyl acrylamide, an acrylonitrile, an aryl acrylate, an aryl methacrylate, an aryl acrylamide, an allyl acrylate, an allyl acrylamide, an allyl methacrylamide, a vinyl methacrylate, a vinyl methacrylamide, a vinyl acrylamide, an allyl vinyl benzene (styrene derivative), a cinnamate, benzophenone, isopropyl thioxanthone, or combinations thereof.

7. The copolymer of any one of claims 1-6, wherein a second portion of the second repeat units comprise a second type of hydrophobic repeat units.

8. The copolymer of claim 7, wherein the second type of hydrophobic repeat units are each independently formed from an alkyl acrylate, an alkyl methacrylate, an alkyl acrylamide, an acrylonitrile, an aryl acrylate, an aryl methacrylate, an aryl acrylamide, a trifluoroethyl methacrylate, a methyl methacrylate, an ethyl methacrylate, a n-propyl methacrylate, a n-butyl methacrylate, an acrylonitrile, a styrene, or combinations thereof.

9. The copolymer of any one of claims 1-8, wherein at least some of the second repeat units do not comprise a cross-linkable moiety.

10. The copolymer of claim 9, wherein the second repeat units that do not comprise a cross-linkable moiety are each independently formed from an acrylate, a methacrylate, an acrylamide, a methacrylamide, a trifluoroethyl methacrylate, a methyl methacrylate, an ethyl methacrylate, a n-propyl methacrylate, a n-butyl methacrylate, acrylonitrile, a styrene, or combinations thereof.

11. The copolymer of any one of claims 1-10, wherein the cross-linkable moiety comprises a carbon-carbon double bond.

12. The copolymer of claim 11, wherein the cross-linkable moiety comprises an allyl (CH2-CH═CH2), a vinyl (—CH═CH2 or —CH═CH—), a vinyl ether (—O—CH═CH2), or a vinyl ester (—CO—O—CH═CH2).

13. The copolymer of any one of claims 1-10, wherein the cross-linkable moiety is polymerized (e.g., cross-linked) via exposure to one or more of a free radical photoinitiator, electromagnetic radiation, high temperature, a redox reaction, or combinations thereof.

14. The copolymer of any one of claims 1-13, wherein each of the ionizable third repeat units is independently formed from a 3-sulfopropyl methacrylate potassium salt, a methacrylate, an acrylate, an acrylamide a styrene derivative comprising one or more of a carboxylate, a carboxylic acid, a sulfonate, a sulfonic acid, an amine, an amino acid, a phosphate, a phosphonic acid, a phosphonium, a boronate, or a boronic acid, or combinations thereof.

15. The copolymer of any one of claims 1-14, wherein the copolymer has a molecular weight of about 10,000 to about 10,000,000 Dalton, preferably about 20,000 to about 500,000 Dalton, and more preferably about 20,000 to about 100,000 Dalton.

16. The copolymer of any one of claims 1-15, wherein the first repeat units constitute about 5 to about 95% by weight of the copolymer, preferably about 10 to about 90%, more preferably about 20 to about 80%, and even more preferably about 25 to about 75%.

17. The copolymer of any one of claims 1-15, wherein the second repeat units constitute about 5 to about 95% by weight of the copolymer, preferably about 10 to about 90%, more preferably about 20 to about 80%, and even more preferably about 25 to about 75%.

18. The copolymer of any one of claims 1-15, wherein the third repeat units constitute about 5 to about 95% by weight of the copolymer, preferably about 10 to about 90%, more preferably about 20 to about 80%, and even more preferably about 25 to about 75%.

19. A cross-linked copolymer network comprising the copolymer of any one of claims 1-18.

20. A thin film composite membrane comprising:
a porous substrate; and
a selective layer comprising the cross-linked copolymer network of claim 19.

21. The thin film composite membrane of claim 20, wherein the average effective pore size of the porous substrate is larger than the average effective pore size of the selective layer.

22. The thin film composite membrane of claim 20, wherein the selective layer is disposed on top of the porous substrate.

23. The thin film composite membrane of claim 20, wherein the selective layer has an average effective pore size of about 0.1 nm to about 2.0 nm.

24. The thin film composite membrane of claim 20, wherein the selective layer has an average effective pore size of about 0.1 nm to about 1.2 nm.

25. The thin film composite membrane of claim 20, wherein the selective layer has an average effective pore size of about 0.5 nm to about 1.0 nm.

26. The thin film composite membrane of any one of claims 20-25, wherein the selective layer has a thickness of about 10 nm to about 10 μm.

27. The thin film composite membrane of any one of claims 20-25, wherein the selective layer has a thickness of about 100 nm to about 2 μm.

28. The thin film composite membrane of any one of claims 20-27, wherein the thin film composite membrane rejects charged solutes and salts.

29. The thin film composite membrane of any one of claims 20-28, wherein the selective layer exhibits sulfate (SO₄²⁻) rejection of greater than 99%.

30. The thin film composite membrane of any one of claims 20-29, wherein the selective layer exhibits sulfate (SO₄²⁻chloride (Cl−) separation factor of greater than 50.

31. The thin film composite membrane of any one of claims 20-29, wherein the selective layer exhibits sulfate (SO₄²⁻chloride (Cl−) separation factor of about 75.

32. The thin film composite membrane of any one of claims 20-31, wherein the selective layer exhibits different anion rejections for salts with the same cation.

33. The thin film composite membrane of any one of claims 20-32, wherein the selective layer exhibits different anion rejections for salts selected among NaF, NaCl, NaBr, Nal, and NaClO₄.

34. The thin film composite membrane of any one of claims 20-33, wherein the selective layer exhibits a fluoride (F−)/chloride (Cl−) separation factor of greater than 5.

35. The thin film composite membrane of any one of claims 20-33, wherein the selective layer exhibits a fluoride (F−)/chloride (Cl−) separation factor of about 8.

36. The thin film composite membrane of any one of claims 20-35, wherein the selective layer exhibits different rejections for monosaccharides and disaccharides.

37. The thin film composite membrane of any one of claims 20-36, wherein the selective layer exhibits a glucose/sucrose separation factor of greater than 10.

38. The thin film composite membrane of any one of claims 20-36, wherein the selective layer exhibits a xylose/sucrose separation factor of greater than 18.

39. The thin film composite membrane of any one of claims 20-38, wherein the selective layer exhibits resistance to fouling by an oil emulsion.

40. The thin film composite membrane of any one of claims 20-39, wherein the selective layer is stable upon exposure to chlorine bleach.

41. The thin film composite membrane of any one of claims 20-40, wherein the selective layer exhibits size-based selectivity between uncharged organic molecules.

42. The thin film composite membrane of any one of claims 20-41, wherein the selective layer exhibits rejection of >99% for neutral molecule with hydrated diameter of about or greater than 1 nm.

43. A method of making a thin film composite membrane comprising:
providing the copolymer of any one of claims 1-18;
depositing the copolymer on to a porous substrate; and
activating the cross-linkable groups of the copolymer to form additional bonds therebetween.

44. The method of claim 43, wherein the step of activating the cross-linkable groups of the copolymer comprises one or more of: exposing the membrane to a free radical photoinitiator, electromagnetic radiation, a free radical photoinitiator and a dithiol, combinations thereof.

45. The method of claim 44, wherein the step of exposing the membrane to a free radical photoinitiator comprises exposing the membrane to a solvent containing the free radical photoinitiator and/or the free radical photoinitiator and a dithiol.

46. The method of claim 44, wherein the step of exposing the membrane to electromagnetic radiation comprises exposing the membrane to ultraviolet light and/or an electron beam.
